(19) United States
(12) Patent Application Publication
(10) Pub. No.: US 2024/0106934 A1
(43) Pub. Date: Mar. 28, 2024

(54) Methods and Apparatus for Differentiated Charging in a Communication Network

(71) Applicant: Telefonaktiebolaget LM Ericsson (publ), Stockholm (SE)

(72) Inventors: Miguel Angel Puente Pestaña, Madrid (ES); Miguel Angel Muñoz De La Torre Alonso, Madrid (ES); Rodrigo Alvarez Dominguez, Madrid (ES)

(21) Appl. No.: 18/252,978

(22) PCT Filed: Jan. 19, 2021
(86) PCT No.: PCT/EP2021/051067

§ 371 Date: May 15, 2023

(30) Foreign Application Priority Data
Nov. 18, 2020 (EP) 20383007.0

(51) Int. Cl. H04M 15/00; H04W 4/24

(52) U.S. Cl. CPC H04M 15/61; H04M 15/58; H04W 4/24

(57) ABSTRACT

A communication network (10) tracking usage information for each of two or more components of traffic associated with the same application identifier provides a basis for differentiating charging with respect to the two or more components. For example, traffic carried by a communication network (10) for a social media application running on a User Equipment (UE) (12) may be identified by a corresponding application identifier. However, the so-identified traffic may include multiple components, such as traffic providing the social-media service(s) and traffic constituting advertising or other ancillary or supplementary content. Tracking and reporting the network usage associated with respective components, i.e., at a granularity finer than that provided by the overall application or traffic flow identifier, provides an advantageous basis for differentiated charging as between the respective components.

### TECHNICAL FIELD

Methods and apparatus disclosed herein provide for differentiated usage tracking and charging in a communication network with respect to different components of application traffic carried by the network.

### BACKGROUND

Communication networks track network usage for multiple reasons, including for charging and billing purposes. Example details regarding charging architectures and interfaces appear in the latest released versions of the following Technical Specifications (TS s) promulgated by the Third Generation Partnership Project (3GPP): TS 32.240, TS 32.274, TS 32.255, TS 32.290, TS 32.291, and TS 32.298.

Generally, charging is based on tracking “usage” of the network by the systems or devices associated with subscribers or other authorized users of the communication network in question. Said more conveniently, charging relates to usage of the communication network by User Equipments (UEs), where an individual UE may be understood as any apparatus that is configured for communicatively coupling to and using the communication network according to the applicable protocols and authorizations. Examples include personal mobility devices, such as tablets, smartphones, etc., but other examples include Machine Type Communication (MTC) devices, such as wireless sensors and systems involved in various industrial applications such as factory automation and utility-services metering. UEs may be fixed or mobile.

“Usage” tracking details depend on the nature of the service being used and how consumption of the service is “metered” within or by the network. For example, the service units consumed by a UE and tracked by the network for voice communications may be defined in terms of minutes. That is, individual minutes of voice-service usage are the quantum of usage that is tracked and charged in one example case. Usage tracking for data services on the other hand may be based on “volume”, such as where the network tracks and, possibly, charges for data-service usage on a per-megabyte basis or on some other unit-volume basis. As a general proposition, a “rating function” within the network will determine the “cost” of any given service at any given time based on a variety of factors, where “cost” is assessed in charging units which may or may not be monetary and are determined by rating the service units that are consumed or authorized for consumption.

A multiplicity of complexities arise regarding charging, not least including the sheer number of variables to be considered, such as agreements between the network operator and the user involved in the chargeable event or session, all applicable charging rules or policies, any special tariffs that are in play, along with the various “product offerings” that may be implicated in the charging. Here, a “product offering” represents purchasable amounts of service, such as prepaid or postpaid offerings that provide for the consumption of services according to defined amounts, or times.

Further, significant complexities arise in “differentiated” charging scenarios, which allow, among other things, different ratings to be applied to different consumption scenarios or costs to be allocated or split across different chargeable parties. For example, the rate “cost” of a voice call may depend on whether the involved user originated the call or received the call. However, the conventional approach to tracking usage—e.g., data flows—according to the identifiers associated with individual applications does not provide for certain kinds of charging differentiation that may be advantageous to network users or network operators or both.

### SUMMARY

A communication network tracking usage information for each of two or more components of traffic associated with the same application identifier provides a basis for differentiating charging with respect to the two or more components. For example, traffic carried by a communication network for a social media application running on a User Equipment (UE) may be identified by a corresponding application identifier, however the so-identified traffic may include multiple components, such as traffic providing the social-media service(s) and traffic constituting advertising or other ancillary or supplementary content. Tracking and reporting the network usage associated with respective components, i.e., at a granularity finer than that provided by the overall application or traffic flow identifier, provides an advantageous basis for differentiated charging as between the respective components.

A method according to an example embodiment is performed by a Session Management Function (SMF) of a communication network. The method includes the SMF receiving a usage report from a User Plane Function (UPF) of the communication network, the usage report including a user equipment (UE) identifier and indicating usage information for each of two or more components of traffic associated with a same application identifier and exchanged with a UE identified by the UE identifier during a communication session involving the UE. Further, the method includes the SMF generating a charging report based on the usage report, the charging report including the UE identifier, the application identifier, and differentiated usage reporting for the two or more components of traffic, and sending the charging report to a Charging Function (CHF) of the communication network, to enable differentiated charging by the CHF for the two or more components of traffic.

In a related embodiment, an SMF for a communication network includes communication circuitry configured to communicatively couple the SMF to one or more other nodes in the communication network, and processing circuitry operatively associated with the communication circuitry. The processing circuitry is configured to: receive a usage report from a UPF of the communication network, the usage report including a UE identifier and indicating usage information for each of two or more components of traffic associated with a same application identifier and exchanged with a UE identified by the UE identifier during a communication session involving the UE. Further, the processing circuitry is configured to generate a charging report based on the usage report, the charging report including the UE identifier, the application identifier, and differentiated usage reporting for the two or more components of traffic, and send the charging report to a CHF of the communication network, to enable differentiated charging by the CHF for the two or more components of traffic.

A method according to another embodiment is performed by a UPF of a communication network, where the method includes the UPF performing differentiated usage tracking for two or more components of traffic associated with a same application identifier, the two or more components of traffic exchanged with a UE identified by a UE identifier during a communication session involving the UE. Further, the method includes the UPF generating a usage report that includes a UE identifier of the UE and indicates component usage information for the two or more components of the traffic, based on the differentiated usage tracking performed by the UPF, and sending the usage report to an SMF, to enable differentiated usage reporting by the SMF for the two or more components of traffic.

In a related embodiment, a UPF includes communication circuitry configured to communicatively couple the UPF to one or more other nodes in the communication network, and further includes processing circuitry operatively associated with the communication circuitry. The processing circuitry is configured to perform differentiated usage tracking for two or more components of traffic associated with a same application identifier, the two or more components of traffic exchanged with a UE identified by a UE identifier during a communication session involving the UE. Further, the processing circuitry of the UPF is configured to generate a usage report that includes a UE identifier of the UE and indicates component usage information for the two or more components of the traffic, based on the differentiated usage tracking performed by the UPF, and send the usage report to an SMF, to enable differentiated usage reporting by the SMF for the two or more components of traffic.

A method according to yet another embodiment is performed by a CHF of a communication network, with the method including the CHF receiving a charging report from an SMF of the communication network, the charging report including a UE identifier, an application identifier, and differentiated usage reporting for two or more components of traffic associated with a same application identifier and exchanged during a communication session with a UE corresponding to the UE identifier. The method further includes the CHF generating one or more Charging Data Records (CDRs) based on the differentiated usage reporting for the two or more components of traffic, and sending the one or more CDRs towards a billing system of the communication network, for differentiated charging with respect to the two or more components of traffic.

In a related embodiment, a CHF for a communication network includes communication circuitry configured to communicatively couple the CHF to one or more other nodes in the communication network, with the CHF further including processing circuitry operatively associated with the communication circuitry. The processing circuitry is configured to receive a charging report from an SMF of the communication network, the charging report including a UE identifier, an application identifier, and differentiated usage reporting for two or more components of traffic associated with a same application identifier and exchanged during a communication session with a UE corresponding to the UE identifier. Further, the processing circuitry of the CHF is configured to generate one or more CDRs based on the differentiated usage reporting for the two or more components of traffic, and send the one or more CDRs towards a billing system of the communication network, for differentiated charging with respect to the two or more components of traffic.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram a communication network according to one or more embodiments.

FIGS. 2A-C are signal flow diagrams of signaling and associated processing by respective network functions of a communication network, according to one or more embodiments.

FIG. 3 is a block diagram of a network node configured for operation as a network function in a communication network, according to one or more embodiments.

FIG. 4 is a logic flow diagram of one embodiment of a method performed by a network node operating as a Session Management Function (SMF) in a communication network, according to one or more embodiments.

FIG. 5 is a logic flow diagram of one embodiment of a method performed by a network node operating as a User Plane Function (UPF) in a communication network, according to one or more embodiments.

FIG. 6 is a logic flow diagram of one embodiment of a method performed by a network node operating as a CHarging Function (CHF) in a communication network, according to one or more embodiments.

### DETAILED DESCRIPTION

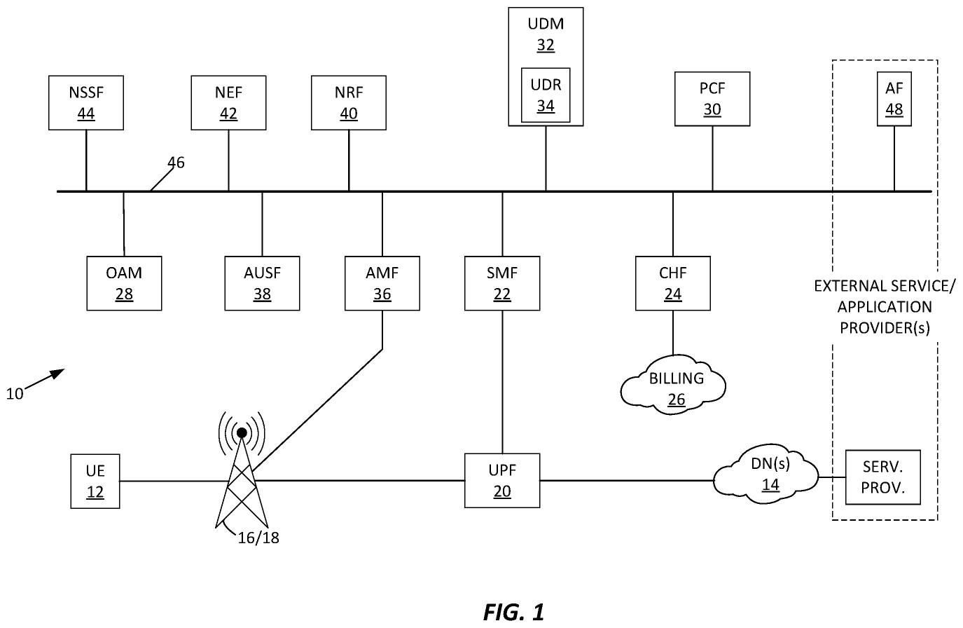

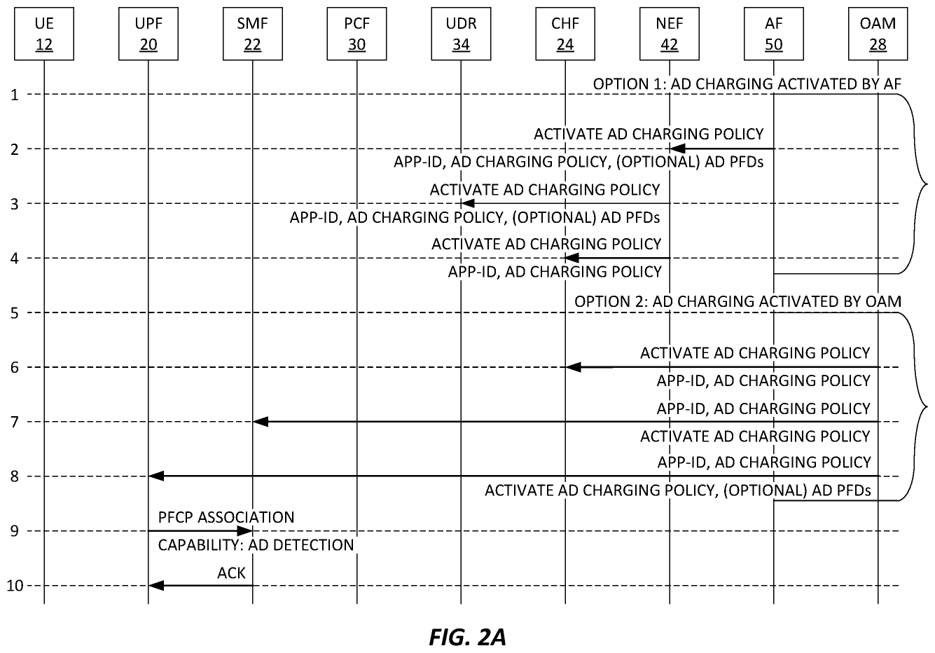

FIG. 1 illustrates an example communication network 10, depicted in example form as a wireless communication network according to service-based architecture contemplated for communication networks conforming to the Fifth Generation (5G) New Radio (NR) specifications. The latest version of 3GPP TS 38.300 offers additional example details regarding 5G network architecture. However, techniques disclosed herein for the various “functions” included in the communication network 10 are not limited to the depicted network architecture; other networks having other architectures will nonetheless have similar functions, regardless of the terminology used in those other contexts. Consequently, the disclosed techniques have applicability to all such networks and their attendant charging operations.

The communication network 10 according to the example depiction provided in FIG. 1 provides one or more communication services to a User Equipment (UE) 12 by communicatively coupling the UE 12 to one or more data networks (DNs) 14 that provide connectivity to one or more application functions/servers denoted as a service provider (SERV. PROV.) in the diagram. For example, the network 10 communicatively couples the UE 12 to the Internet or other packet data networks (PDNs), enabling the UE 12 to access data services such as YOUTUBE and FACEBOOK. The traffic flow(s) carried by the communication network 10 for a particular application are generally identified by a corresponding application identifier that is tied, for example, to the network domain of the service provider/application in question.

One or more radio access nodes 16 in a Radio Access Network (RAN) 18 portion of the communication network provide an air interface used by the UE 12 for connecting to the communication network 10 according to the applicable radio-signal structure, frequencies, timings, protocols, and authorizations. In the parlance of 5G, the term “gNB” refers to the one or more radio access nodes 16, and it should be understood that the communication network 10 may include potentially many radio access nodes 16 not necessarily alike in terms of coverage areas, air interface particulars, etc. Likewise, the communication network 10 may include functions or other entities not shown in FIG. 1 and may include multiple instances of any one or more of the entities that do appear in the diagram, and at least some of the entities may be cloud-based.

Further example elements of the example communication network 10 include a User Plane Function (UPF) 20, a Session Management Function (SMF) 22, a CHarging Function (CHF) 24, which is associated with a billing system 26. Still further, the communication network includes an Operations, Administration, and Maintenance (OAM) node 28, a Policy Control Function (PCF) 30, a Unified Data Management (UDM) node 32 with a Uniform Data Repository (UDR) 34, an Access and Mobility Management Function (AMF) 36, an AUthentication Server Function (AUSF) 38, a Network Repository Function (NRF) 40, a Network Exposure Function (NEF) 42, and a Network Slice Selection Function (NSSF) 44. A network-based interconnection 46 couples the various functions together and may also provide for inter-function communications with an Application Function (AF) 48, associated with an external service provider/application. Also, note that there may be one or multiple instances of any of the depicted functions or nodes within the communication network 10.

Within the context of the communication network 10, control plane functions take care of user connection management, perform user authentication, and define Quality-of-Service (QoS) policies. User plane functions handle data traffic forwarding, i.e., the conveyance of data through the communication network 10 for respective UEs 12 connected to the communication network 10. Broadly, the user plane carries user traffic in the communication network 10 while the control plane carries the various signals or signaling needed to manage user connectivity, mobility, authorization, and charging, with respect to UEs 12 that use the communication network 10.

For example, the UPF 20 acts as a packet gateway for the UEs 12 that it supports, including providing packet routing and forwarding. The UPF 20 also manages Quality-of-Service (QoS) with respect to user traffic. Complementing operation of the UPF 20, the SMF 22 provides session management and IP address allocation, and controls policy enforcement. Particularly, the SMF 22 receives Policy and Charging Control (PCC) rules from the PCF 30 and configures UPF 20 accordingly.

The CHF 24 provides or otherwise allows charging services to be offered for authorized network functions. The OAM node 28 provides various processes and tools for network management, while the PCF 30 works with CHF 24 for usage monitoring and applies defined policy rules to control-plane functions and policy enforcement to user-plane functions. In particular, the PCF 30 provides PCC (Policy and Charging Control) rules to the Policy Control and Enforcement Function (e.g., the involved SMF 22/UPF 20) that enforces policy and charging decisions according to provisioned PCC rules.

The UDM node 32 manages data for access authorization, user registration, etc. The included or associated UDR 34 stores various user data, such as customer profile and authentication information and associated authentication keys.

The AMF 36 handles mobility and connection management tasks with respect to the UE connections that it supports, while the AUSF 38 performs authentication of UEs 12 that attempt to connect to the communication network 10. The NRF 40 provides network function (NF) service registration and discovery, enabling respective NFs within the communication network to identify appropriate services in one another. Further, the NEF 42, as the name suggests, provides access to exposed network services and capabilities, e.g., allowing external service providers to interact with and gain access to the exposed services and capabilities. Still further, the NSSF 44 allows UEs 12 to be placed on selected “slices” of the communication network 10. A “network slice” may be understood as a virtual network instantiated on the underlying physical networking components comprised in the communication network 10, with slicing providing robust mechanisms for meeting Service Level Agreements (SLAs) for specific subscribers, isolating different services, etc. See the latest version of 3GPP TS 23.501 for example details regarding network slicing.

Turning from specifics about the various NFs operating within the communication network 10, many applications or apps such as YOUTUBE include advertisements along with the requested content. The involved user may not always expect or want the advertising. In this specific example, the “user” may be a human using the YOUTUBE application on a UE 12 that connects to the YOUTUBE service using the communication network 10 for access. More broadly, the term “user” may be understood as referring at least to the UE 12 that is “using” the communication network.

In practice, the advertisement-related traffic that is delivered along with the traffic conveying the requested content is time and resource consuming. Some services or web sites allow users to filter the ads to be received, but this can only be done once the user has accessed such web sites for the first time. Moreover, a so-called “affiliate marketing” enjoys increasing prevalence, where a merchant rewards one or more affiliates for each visitor or customer brought about by affiliate's marketing efforts. This emerging marketing practice incentivizes the delivery of advertising content in conjunction with delivering the application or service content particularly requested by users. Understandably, users who would prefer not to receive the advertising content at all certainly do not want to be charged for such content, or at least not be charged on the same basis as the requested content.

Making matters worse, some advertising content is “larger” than the requested content or is otherwise more resource-intensive with respect to the allocation of routing resources and radio resources within the communication network. For example, a web page that is primarily text and static images may also contain one or more advertising videos that auto-play when a user accesses the web page.

Conventional approaches to charging provide, among other things, the ability to change the “chargeable” party when a communication session is being established or even during an established communication session. See, for example, the current version of 3GPP TS 29.122. In the context of TS 29.122, the ChargeableParty Application Programming Interface (API) is a RESTful API that allows the Session Control Server (SCS)/Application Server (AS) to either request to sponsor the traffic from the beginning or to request becoming the chargeable party at a later point in time. The ChargeableParty API defines a set of data models, resources and the related procedures for the creation and management of the AS sessions with chargeable party change. The corresponding JavaScript Object Notation (JSON) schema for the representation of the resources and operations defined by the Chargeable API is provided in its complete form in Annex A.5. See, e.g., Tables 5.5.2.1.1.-1, 5.5.2.1.3-1, and 5.5.2.1.2-1 in TS 29.122.

A notable shortcoming of the chargeable-party feature and other features of existing techniques for tracking network usage and providing for differentiated charging is that current approaches to charging are based on usage reports from the UPF on a per service/application basis. Tracking usage and assessing charges at the application level of granularity has many problems regarding differentiated charging, such as when zero rating of advertising content is desired. Here, “zero rating” means that no charges are assessed to the involved user or, more specifically, the subscriber “account” that would otherwise be assessed for the network usage associated with providing the advertising content to the user. Particularly, the existing 5G reporting and charging mechanisms have several limitations, including the fact that it is not possible to apply different charging policies for different “components” of application traffic that commonly identified within the network under the same application identifier.

Correspondingly, conventional UPF implementations do not provide for differentiated usage tracking or reporting for user traffic at a granularity below the application level. Similar or related, follow-on limitations apply for conventional implementations of SMFs and CHFs. Particularly, in the case of advertisement zero rating or other desired charging differentiation scenarios, it is not possible to define specific traffic filters to identify the advertisement traffic, because such traffic is dynamic and the traffic comes from or is associated with application servers belonging to the advertisers or their agents and the associated IP addresses unknown to the application in which the advertisements are shown. Similarly, the flow descriptors or traffic filters needed to identify and classify advertising traffic within an overall flow of application traffic cannot be defined in advance, because such traffic is dynamic and generally involves the use of IP addresses unknown to the involved application.

In an example embodiment, a solution to the above challenges associated with differentiated charging of advertising content delivered as a component of application traffic includes the activation of advertisement charging policies. In this disclosure, the term “application traffic” means user traffic carried by the communication network 10 for a particular UE 12/communication session. For a particular application, the corresponding application traffic is identified by a defined application identifier (application or app ID). As an example, a UE 12 establishes a communication session with an external service provider, e.g., providing an Over-the-Top (OTT) service with the communication network 10 acting as an access network. Correspondingly, the user traffic carried by the communication network 10 for the communication session is associated with and identified by an application identifier, although such “application traffic” may include multiple components, such as a primary component constituting the “service” in question, along with supplementary content, such as advertising.

One option for activating advertisement charging policies is as follows. An AF 48 belonging to the application showing advertisements, sends a message to the NEF 42 to activate a specific charging policy (e.g., zero rating) for the traffic belonging to the advertisements showed by the application. The NEF 42 stores the above information in the UDR 34 within the application's data and the NEF 42 provides charging policy/policies for the advertisements to the CHF 24. This arrangement allows for differentiated charging as between the component(s) of application traffic associated with providing the involved service and the component(s) of application traffic constituting the advertisements in question.

As another option for activating advertisement charging policies, the OAM 28 in one or more embodiments is configured to activate the advertisement charging policies in the CHF 24, the SMF 22, and UPF 20. Correspondingly, at the establishment of a Packet Data Unit (PDU) session—as an example “communication session”—the PCF 30 retrieves the advertisement charging policies for the involve application from the UDR 34 and provides them to the SMF 22. The SMF 22 creates new URR (Usage Reporting Rules) to install differentiated reporting for tracked usage with respect to the component(s) of the application traffic that constitute the advertising versus the other or remaining component(s) of the application traffic. To provide the differentiated usage tracking needed for differentiated charging reporting by the SMF 22, the UPF 20 in one or more embodiments uses internal heuristics or machine-learning processes, to identify the traffic component(s) constituting the advertising and tracks the usage accordingly. For example, the UPF 20 tracks the volume of data exchanged with the UE 12 for the advertising component(s) of the application traffic carried by the communication network 10 for the involved PDU session, and tracks the volume of data exchanged with the UE 12 for the “service” component(s) of the application traffic carried by the communication network 10 for the involved PDU session. Again, the “service” component(s) of the application traffic may be understood as the component(s) native to the underlying application/service, or may be more broadly understood as the application traffic minus that portion detected and tracked as advertising content.

The UPF 20 sends the differentiated usage tracking reports, e.g., differentiated volume reports, to the SMF 22. In an example, the differentiated usage tracking reports include a tracked volume for the advertising component(s) of the application traffic and a tracked volume for the non-advertising component(s) of application traffic. In turn, the SMF 22 sends differentiated charging records to the CHF 24, e.g., including the separately-tracked volumes of advertising and non-advertising content within the application traffic carried by the communication network for the involved UE 12, the involved application, and the involved PDU session.

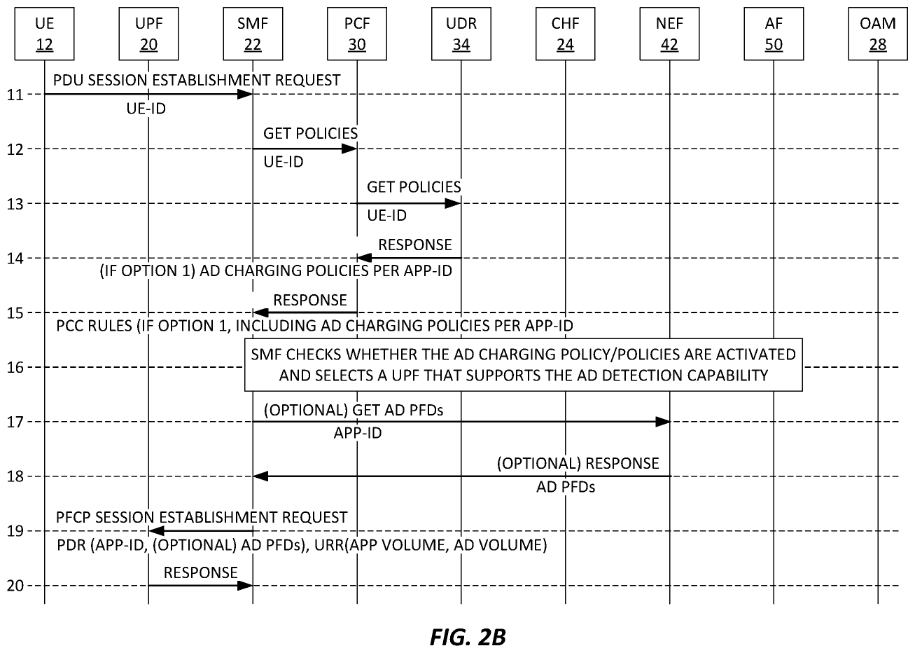

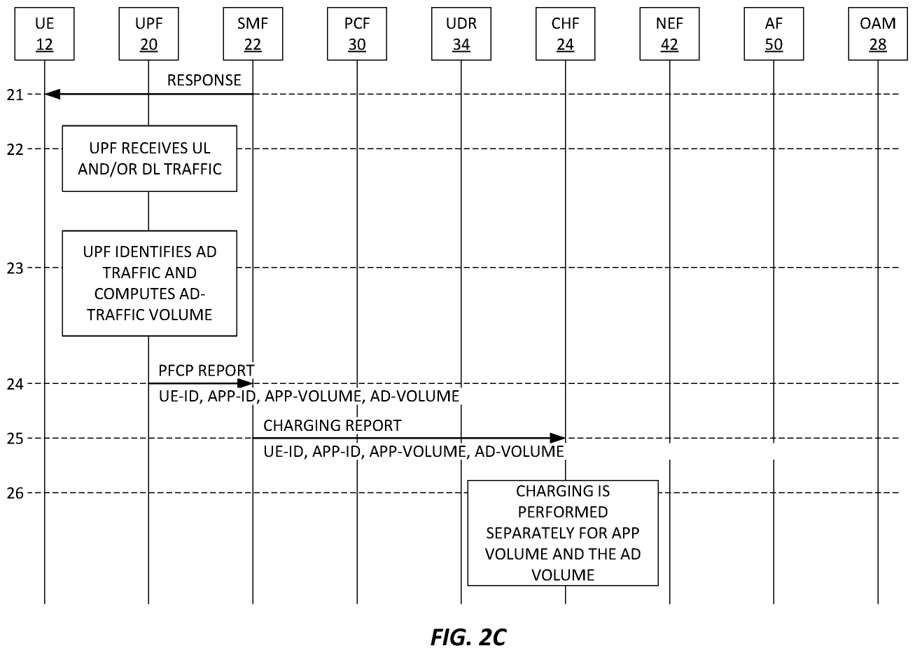

FIGS. 2A-C depict an example signaling flow for differentiated usage tracking, reporting, and charging with respect to a traffic flow that is identified by an application identifier and includes one or more advertising components and one or more non-advertising components. As a first option—Option 1—the differentiated charging for the advertising component(s) is activated by an AF 48. According to Option 1 (Steps 1-4 in the diagram), at Step 1 the AF 48 sends to the NEF 42 an Activate Advertisement (“Ad”) charging policy message that includes the (a) app-ID and (b) the applicable Ad charging policy.

Example Ad charging policies are any of: (1) an instruction to request rating groups or changes to rating groups for Ad traffic component, e.g. from chargeable to non-chargeable (or sponsored), (2) the application of a non-chargeable rating (zero rating) only to the Ad traffic component, while the “regular” or remaining components of application traffic shall be charged normally, or (3) all the application traffic, including the Ad traffic component and the regular or remaining components, is non-chargeable if advertisements are detected within the traffic flow commonly identified by the App-ID. Here, the “regular” components of the application traffic may be understood as anything not detected/identified as advertisements or may be component(s) of the application traffic that are detected/identified as constituting the underlying service/application associated with the App-ID.

The charging policy message may further include one or more Packet Flow Descriptors (PFDs) for use in detecting/identifying the Ad traffic component(s) within the overall traffic flow identified by the App-ID. That is, the UPF 20 that is handling the involved PDU session for the involved UE 12 uses the PFD(s) as filters for traffic classification, for detection/differentiation of components of the application traffic. As an example, the PFD(s) provide for identification of traffic components corresponding to SNI=googleadservices.com and SNI=securepubads.g.doubleclick.net, where “SNI” denotes “Server Name Identification”. The NEF 42 stores information from the charging policy message in the UDR 34 and sends the charging policies on a per app-ID basis, as received from AF 48, to the CHF 24.

As an alternative to Option 1, a second option denoted as “Option 2” may be used. Of course, the communication network 10 in one or more embodiments supports both Option 1 and Option 2, with the particular option used for any given communication session being dependent on, for example, any one or more of the involved application, the involved UE 12, or other variables.

According to Option 2 (Steps 5-8 in the diagram), differentiated charging for advertisements carried within the traffic flow of the application are activated by the OAM 28, e.g., as part of configuration procedures decided by the network operator. In such cases, the OAM 28 configures the CHF 24 with the applicable charging policy for an application. The configuration includes (a) the App-ID and (b) the charging policy, which may be as described above in the context of Option 1. The OAM 28 also configures the SMF 22 with the applicable charging policy for the App-ID, e.g., with the same or similar information as provided to the CHF 24. Similarly, the OAM 28 configures the UPF 20 with the charging-policy details for the App-ID and may further provide the UPF 20 with the applicable PFDs.

At Steps 9 and 10, the UPF 20 establishes a Packet Flow Control Protocol (PFCP) association with the SMF 22. Notably, as part of the association signaling, the UPF 20 according to one or more embodiments provides the SMF 22 with capability information indicating that the UPF 20 supports differentiated usage tracking for respective components of application traffic at least for one or more applications, and the SMF 22 acknowledges the association.

Advancing to FIG. 2B, at Step 11, the UE 12 initiates establishment of a PDU session establishment and the SMF 22 at Step 12 sends a request for the applicable policies to the PCF 30. At Step 13, the PCF 30 sends a request to the UDR 34 for the applicable policies and the UDR 34 responds at Step 14 with the applicable policies. If Option 1 was used, the response from the UDR 34 includes the differentiated charging policies to be applied per App-ID.

At Step 15, the PCF 30 responds to the SMF 22 with the PCC rules. If Option 1 was used, the response includes the differentiated charging policies per App-ID. At Step 16, the SMF 22 checks that the differentiated charging policies are activated and selects a UPF 20 for the PDU session that supports the differentiated charging policies—i.e., a UPF 20 that has indicated support for differentiated usage tracking for respective components of an application's traffic.

At Step 17, which features optional additional signaling and processing, the SMF 22 queries the NEF 42 for the PFDs to be used for differentiating the involved components of the application traffic, e.g., to be used for differentiating between a regular component of the application traffic and advertising components of the application traffic. The NEF 42 responds to the query by retrieving the PFDs from the UDR 34 and provides them at Step 18 to the SMF 22. Correspondingly, at Step 19, the SMF 22 sends a PFCP session establishment request to the selected UPF 20. As an example, for supporting/configuring differentiated usage tracking by the UPF 20, the request includes one or more Packet Detection Rules (PDRs) that are based on the App-ID, the PFDs (if retrieved by the SMF 22) and Usage Reporting Rules (URRs). The URR(s) include, for example, an indication to report the tracked volume for advertising component(s) of the application traffic separately from the tracked volume reported for the regular or remaining component(s) of the application traffic. Further URRs include, for example, configuration information for periodic reporting, reporting based on volume thresholds, etc.

At Step 20 the UPF 20 acknowledges the PFCP session establishment request and, advancing to FIG. 2C, the SMF 22 sends a PDU Session Establishment response towards the UE 12 at Step 21. Upon PDU session establishment, the UE 12 at Step 22 sends application traffic towards the UPF 20 and/or receives application traffic from the UPF 20, where the application traffic is carried within the communication network 10 for the ongoing PDU session under the applicable App-ID. In support of differentiated usage tracking with respect to the application traffic, the UPF 20 at Step 23 performs differentiated usage tracking for two or more components of the application traffic, e.g., differentiated (data) volume tracking for one or more advertising components in the application traffic versus one or more other or remaining components of the application traffic.

Such tracking may be understood as ongoing or continuing for the duration of the PDU session. Therefore, the PFCP reporting performed by the UPF 20 at Step 24 may be performed multiple times, e.g., triggered periodically during the PDU session and/or triggered according to volume thresholds. Each such differentiated usage reporting by the UPF 20 to the SMF 22 includes, for example, the UE ID, the App-ID, and differentiated usage tracking. For example, at Step 25, the UPF 20 reports an overall volume of the application traffic, App-volume, along with reporting the volume of advertising content included within that overall volume. Of course, reporting variations are contemplated. For example, the UPF 20 may have been configured to track volumes or other “usage” metrics for two or more respective components of the application traffic and its differentiated usage tracking reporting to the SMF 22 may include a separate tracked usage for each component being tracked within the application traffic.

With the above configurations and operations in place, the UPF 20 identifies the component(s) of application traffic that are advertising or some other differentiated type and provides the SMF 22 with differentiated usage tracking in the usage tracking reports sent from the UPF 20 to the SMF 22. Providing the SMF 22 with differentiated usage tracking enables the SMF 22 to generate differentiated charging reports that include, for example, the UE-ID, the App-ID, and the differentiated usage tracking information, e.g., differentiated volumes for two or more components of the application traffic corresponding to the App-ID. Sending differentiated charging reports from the SMF 22 to the CHF 24 correspondingly enables the CHF 24 to generate differentiated Charging Data Records (CDRs) that allow the communication network 10 to provide differentiated charging for the tracked components of the application traffic, e.g., via the billing system 26.

Applying the above-described examples of differentiated usage tracking, reporting, and charging to a Fourth Generation (4G) network context, the operations ascribed to the AF 48 are performed by a Session Control Server (SCS)/Application Server (AS), the operations ascribed to the NEF 42 are performed by a Services Capability Exposure Function (SCEF), the operations ascribed to the PCF 30 are performed by a Policy and Charging Rules Function (PCRF), the operations ascribed to the SMF 22 are performed by a Packet Gateway for the control plane (PGW-C) or a Traffic Detection Function for the control plane (TDF-C), and the operations ascribed to the UPF 20 are performed by a user-plane PGW or TDF (PGW-U or TDF-U).

Among the multiplicity of advantages or benefits flowing from the above example operations, charging can be performed on a per application component basis. And, if desired by the network operator or a business partner, zero rating can be applied to the advertising component(s) with the traffic flow of an application, or the zero rating can be applied to the whole traffic flow in response to detecting that one or more components of the traffic flow are advertising. Further, while differentiating between service and advertising components of application traffic has particular advantages in at least some operational and business scenarios, the differentiated usage tracking, reporting, and charging contemplated herein is not limited to differentiating between advertising and non-advertising components of application traffic.

Indeed, the techniques apply to multiple kinds, types, or categories of traffic components that are carried within the traffic flow for an application, with the corresponding traffic flow being identified in the aggregate within the communication network 10 by the applicable application identifier, for the involved UE 12. Of course, in one or more embodiments, the proposed technique(s) provide an efficient solution enabling differentiated charging for advertisements in 5GC.

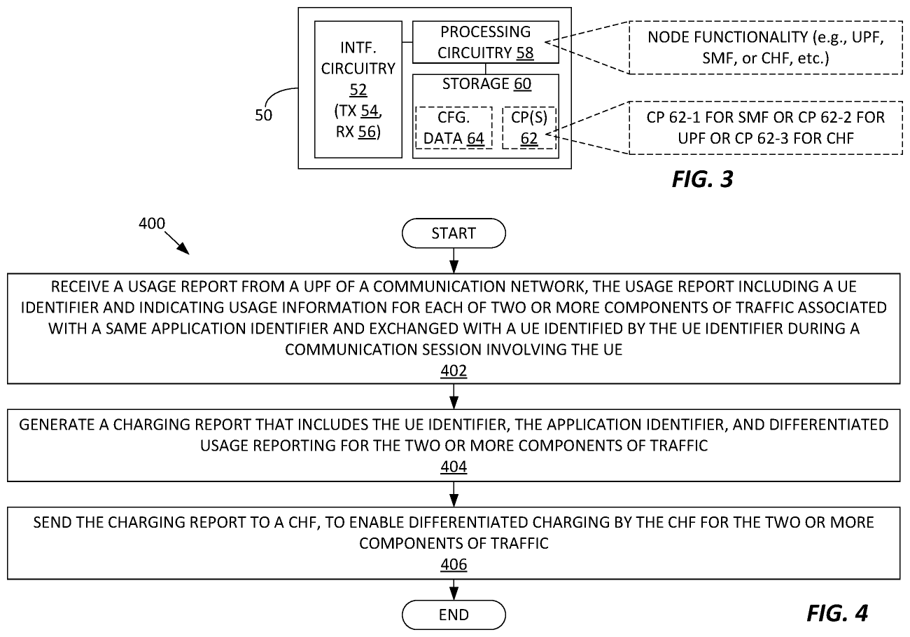

FIG. 3 illustrates a network node 50 configured for operation in a communication network, such as the communication network 10 depicted in FIG. 1. In an example embodiment, the network node 50 comprises a computer server, for example, executing one or more computer programs by which the computer server is specially adapted to carry out the functionality at issue. The computer server has a computer network interface, for example, for exchanging information with other computers/nodes in the network.

More broadly, the network node 50 in one or more embodiments comprises interface circuitry 52, including one or more types of transmitter circuitry 54 and one or more types of receiver circuitry 56, for sending messages or other signaling to one or more other nodes of the communication network 10 and receiving messages or other signaling from one or more other nodes of the communication network 10. The interface circuitry 52, also referred to as communication circuitry, comprises the physical layer transmit/receive circuitry for wired and/or wireless mediums, along with the associated clocking and protocol management processors, unless such functionality is integrated with the processing circuitry 58 that is further included in the network node 50.

The processing circuitry 58 comprises fixed or dedicated circuitry, programmatically configured circuitry, or a mix of fixed and programmatically configured circuitry. For example, the processing circuitry 58 comprises any number of microprocessors, microcontrollers, Digital Signal Processors (DSPs), Field Programmable Gate Arrays (FPGAs), Application Specific Integrated Circuits (ASICs), Complex Programmable Logic Devices (CPLDs), or other digital processing circuitry.

In at least one embodiment, the processing circuitry 58 comprises one or more types of the above-mentioned computer processors, which processor(s) are specially adapted to carry out the functionality at issue, based on the execution of computer program instructions from storage 60, e.g., instructions from one or more computer programs (CPs) 62 held in the storage 60. The storage 60 additionally or alternatively stores one or more items of configuration data (CFG. DATA) 64, which may comprise pre-provisioned information or dynamically-acquired and stored information, e.g., such as policy-related information or other information supporting differentiated usage tracking, reporting, or charging as disclosed herein.

The storage 60 comprises one or more types of computer-readable media and, for example, includes both short-term volatile storage, such as used by the processing circuitry 58 for program execution and/or working data, along with long-term non-volatile storage for retaining the computer programs 62 and/or the configuration data 64. In either case, the storage 60 provides persistent storage, where persistent storage means having some finite duration but not necessarily implying permanent or unchanging storage. Examples of the storage 60 include any one or more memory circuits or devices or storage devices, such as SRAM, DRAM, NVRAM, EEPROM, FLASH, Solid State Disk (SSD), electromagnetic disk, etc., and in one or more embodiments, the storage 60 provides non-transitory storage for the computer program instructions that, when executed by the processing circuitry 58, cause the network node 50 to perform the operations at issue.

As for the particulars of those operations, they depend on the intended functionality of the network node 50. For example, the computer network 10 may include multiple instances of the network node 50, with one or more configured as UPFs 20, one or more configured as SMFs 22, one or more configured as CHFs 24, and so on. One instance or copy of the network node 50 operates as a UPF 20 based on the particulars of the one or more computer programs 62 that the node 50 stores and executes, and the same holds for other node instances, with their respective computer programs 62 providing for SFM operation, CHF operation, etc.

For example, the network node 50 is a computer server of other computer-based processing system and operates as an SFM 22 based on its execution of a computer program 62-1, or operates as a UPF 20 based on its execution of a computer program 62-2 or operates as a CHF 24 based on its execution of a computer program 62-3. Each of the computer programs 62 stored in the storage 60 or as embodied in some other non-transitory computer-readable medium forms a computer program product that, when the included program instructions are executed by the processing circuitry 58 of the network node 50, configures the network node 50 to perform the operations embodied in the computer program instructions, e.g., for operation of the network node 50 as an SMF 22, a UPF 20, or a CHF 24. And, of course, there may be variations in the node architecture and/or communication and processing capabilities, as between network nodes 50 that are operative respectively as UPFs 20 and SMFs 22 and CHFs 24.

Further, the network node 50 may be instantiated as a virtual node, meaning that it is realized in a virtual processing environment, such as provided by a virtual machine running on a host computer platform in a cloud processing center. However, even in virtualized form, it will be understood that underlying physical processing and interface circuitry are involved in carrying out the node functionality.

Thus, in an example of a network node 50 configured as an SMF 22 for a communication network 10, the SMF 22 includes communication circuitry 52 that is configured to communicatively couple the SMF 22 to one or more other nodes in the communication network 10. Further, the SMF 22 includes processing circuitry 58 that is operatively associated with the communication circuitry 52 and configured to receive a usage report from a UPF 20 of the communication network 10, where the usage report includes a UE identifier (UE-ID) and indicates usage information for each of two or more components of traffic that is associated with a same application identifier (APP-ID) and exchanged with a UE 12 identified by the UE identifier during a communication session involving the UE 12.

Further, the processing circuitry 58 in this SMF-based example of the network node 50 is configured to generate a charging report based on the usage report. In one or more embodiments, the charging report includes the UE identifier, the application identifier, and differentiated usage reporting for the two or more components of traffic, and the processing circuitry 58 is configured to send the charging report to a CHF 24 of the communication network 10, to enable differentiated charging by the CHF 24 for the two or more components of traffic.

For example, the two or more components of traffic are carried in a traffic flow associated with the application identifier and comprise a principal component comprising primary traffic and an adjunct component comprising supplementary traffic. Correspondingly, the differentiated usage reporting by the SMF 22 enables differentiated charging by the CHF 24 for the primary traffic and the supplementary traffic. The primary traffic comprises, for example, application traffic constituting a service provided by an application associated with the application identifier and the supplementary traffic comprises application traffic constituting advertising content exchanged with the UE 12 in conjunction with providing the service.

In one or more embodiments, the processing circuitry 58 for SMF operation is further configured to fetch a charging policy responsive to receiving a PDU session establishment request from the UE 12, with the PDU session establishment request indicating the application identifier, and, in response to the charging policy indicating that differentiated usage reporting and charging applies for the application identifier, select the UPF 20 to support the PDU session as the communication session, based on determining that the UPF supports differentiated usage reporting. Additionally, in one or more embodiments, the processing circuitry 58 for SMF operation is configured to fetch one or more PFDs associated with the application identifier, and provide the one or more PFDs to the UPF 20, to support differentiated usage reporting by the UPF 20.

To provide the one or more PFDs to the UPF 20, the processing circuitry 58 for SMF operation may be configured to include the one or more PFDs in a PFCP session establishment request sent to the UPF 20 from the SMF 22 in conjunction with establishing, as the communication session, a PDU session between the UE 12 and a DN 14 associated with the application identifier.

The usage information for each of the two or more components of the traffic associated with the same application identifier comprises, for example, service unit consumption information for each of the two or more components. The service unit consumption information indicates a time or volume measure associated with each of the two or more components. Of course, other units or quantum of service consumption may be tracked for differential charging, depending on the nature of the service/application in question or based on other factors.

FIG. 4 illustrates a method 400 according to one embodiment, with the method 400 performed by an SMF 22 of a communication network 10. The method 400 includes the SMF 22 receiving (Block 402) a usage report from a UPF of the communication network 10, the usage report including a UE identifier and indicating usage information for each of two or more components of traffic associated with a same application identifier and exchanged with a UE 12 identified by the UE identifier during a communication session involving the UE. The communication session is a PDU session for example, involving the UE 12 and an external DN 14.

The method 400 further includes the SMF 22 generating (Block 404) a charging report based on the usage report, the charging report including the UE identifier, the application identifier, and differentiated usage reporting for the two or more components of traffic. Further, the method 400 includes the SMF 22 sending (Block 406) the charging report to a CHF 24 of the communication network 10, to enable differentiated charging by the CHF 24 for the two or more components of traffic.

The method 400 in one or more embodiments includes the SMF 22 fetching a charging policy responsive to receiving a PDU session establishment request from the UE 12. The PDU session establishment request indicates the application identifier and, in response to the charging policy indicating that differentiated usage reporting and charging applies for the application identifier, the method 400 includes the SMF 22 selecting the UPF 20 to support the PDU session as the communication session, based on determining that the UPF 20 supports differentiated usage reporting. That is, in a case where the SMF 22 determines that differentiated charging applies, the SMF 22 decides which UPF 20 to select for supporting the communication session based at least in part on considering which UPFs 20 from among the available UPFs 20 support differentiated usage tracking. Of course, it may be that all UPFs 20 in the network provide such support.

The method 400 may further include the SMF 22 fetching one or more PFDs associated with the application identifier, and providing the one or more PFDs to the UPF 20, to support differentiated usage reporting by the UPF 20. For example, the SMF 22 provides the one or more PFDs to the UPF 20 in a PFCP session establishment request sent to the UPF 20 from the SMF 22 in conjunction with establishing, as the communication session, a PDU session between the UE 12 and a DN 14 associated with the application identifier.

In a case where a network node 50 is configured for operation as a UPF 20, e.g., based on the computer programs 62 stored in the network node 50 including program instructions for effectuating UPF operations, the communication circuitry 52 is configured to communicatively couple the UPF 20 to one or more other nodes in the communication network 10. The processing circuitry 58 is operatively associated with the communication circuitry 52 and is configured to perform differentiated usage tracking for two or more components of traffic associated with a same application identifier, the two or more components of traffic exchanged with a UE 12 identified by a UE identifier during a communication session involving the UE. Further, the processing circuitry 58 for UPF operation is configured to generate a usage report that includes a UE identifier of the UE and indicates component usage information for the two or more components of the traffic, based on the differentiated usage tracking performed by the UPF 20. Still further, the processing circuitry 58 for UPF operation is configured to send the usage report to an SMF 22, to enable differentiated usage reporting by the SMF 22 for the two or more components of traffic.

The usage report comprises, for example, a PFCP report generated and sent by the UPF to the SMF 22 on a periodic basis, while a corresponding PFCP session is active between the UPF 20 and the SMF 22. For example, the two or more components of traffic belong to a same PDU session established between the UE 12 and a DN 14 via the communication network 10, as the communication session. The PFCP session corresponds with the PDU session in this example.

To perform the differentiated usage tracking, the processing circuitry 58 for UPF operation is configured in one or more embodiments to distinguish between the two or more components of traffic by detecting SNIs within traffic exchanged with the UE 12 for the PDU session. Additionally, or alternatively, the processing circuitry 58 for UPF operation is configured to use traffic heuristics and/or ML processes to distinguish between the two or more components of traffic within traffic exchanged with the UE 12 for the PDU session. In at least one embodiment, the processing circuitry 58 of UPF operation is configured to receive PFDs from the SMF 22 and use the PFDs to distinguish between the two or more components of traffic exchanged with the UE 12 for the PDU session. Further, in at least one embodiment, the processing circuitry 58 for UPF operation is configured to perform the differentiated usage tracking in response to receiving information from the SMF indicating that differentiated usage tracking applies for the communication session.

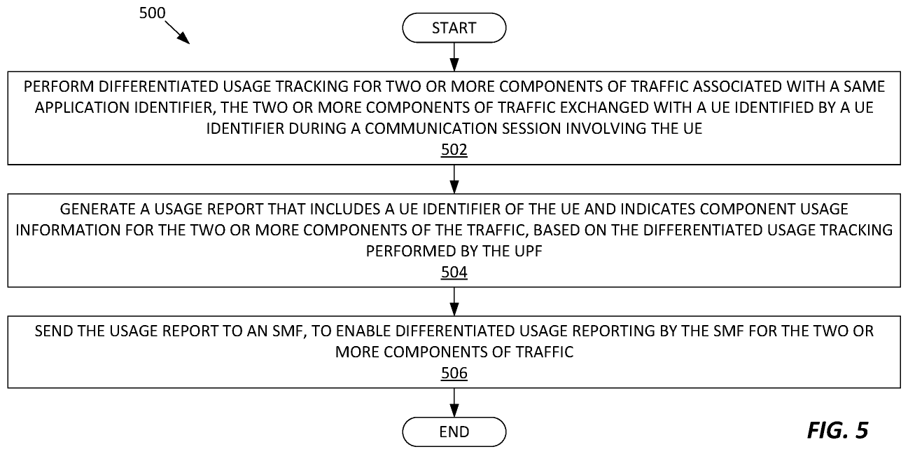

FIG. 5 illustrates a method 500 performed by a UPF 20 of a communication network 10, where the method includes performing (Block 502) differentiated usage tracking for two or more components of traffic associated with a same application identifier, the two or more components of traffic exchanged with a UE 12 identified by a UE identifier during a communication session involving the UE 12. Further, the method 500 includes the UPF 20 generating (504) a usage report that includes a UE identifier of the UE 12 and indicates component usage information for the two or more components of the traffic, based on the differentiated usage tracking performed by the UPF 20, and sending (Block 506) the usage report to an SMF 22, to enable differentiated usage reporting by the SMF 22 for the two or more components of traffic.

Performing the differentiated usage tracking comprises any one or more of: distinguishing between the two or more components of traffic by detecting SNIs within traffic exchanged with the UE for the PDU session, or using traffic heuristics and/or ML processes to distinguish between the two or more components of traffic within traffic exchanged with the UE 12 for the PDU session. Also, as noted, the differentiated usage tracking may be based on the UPF 20 receiving PFDs from the SMF 22 and using the PFDs to distinguish between the two or more components of traffic exchanged with the UE 12 for the PDU session. Further, in one or more embodiments of the method 500, the UPF 20 performs the differentiated usage tracking in response to receiving information from the SMF 22 indicating that differentiated usage tracking applies for the communication session.

In a case where a network node 50 is configured for operation as a CHF 24 in a communication network 10, the communication circuitry 52 is configured to communicatively couple the CHF 24 to one or more other nodes in the communication network 10. The processing circuitry 58 is operatively associated with the communication circuitry 52 and for CHF operation is configured to receive a charging report from an SMF 22 of the communication network 10. The charging report includes a UE identifier, an application identifier, and differentiated usage reporting for two or more components of traffic associated with a same application identifier and exchanged during a communication session with a UE 12 corresponding to the UE identifier. Correspondingly, the processing circuitry 58 for CHF operation is configured to generate one or more CDRs based on the differentiated usage reporting for the two or more components of traffic, and send the one or more CDRs towards a billing system 26 of the communication network 10, for differentiated charging with respect to the two or more components of traffic.

Further, in at least one embodiment, the processing circuitry 58 for CHF operation is configured to activate a charging policy associated with the application identifier in response to signaling incoming to the CHF 24 from a NEF 42 or an OAM function 28 of the communication network 10. The charging policy defines the differentiated charging to be used by the CHF 24 for the two or more components of traffic.

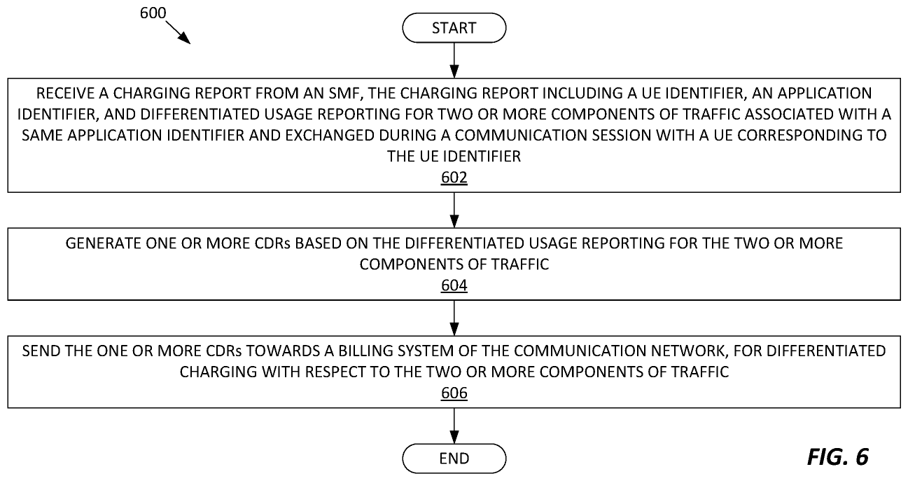

FIG. 6 illustrates a method 600 according to one or more embodiments, where the method 600 is performed by a CHF 24 of a communication network 10. The method 600 includes the CHF 24 receiving (Block 602) a charging report from an SMF 22 of the communication network 10. The charging report includes a UE identifier, an application identifier, and differentiated usage reporting for two or more components of traffic associated with a same application identifier and exchanged during a communication session with a UE 12 corresponding to the UE identifier. The method 600 further includes the CHF 24 generating (Block 604) one or more CDRs based on the differentiated usage reporting for the two or more components of traffic, and sending (Block 606) the one or more CDRs towards a billing system of the communication network, for differentiated charging with respect to the two or more components of traffic.

In at least one embodiment, the method 600 further includes, in response to signaling incoming to the CHF 24 from a NEF 42 or an OAM function 28 of the communication network 10, the CHF 24 activating a charging policy associated with the application identifier. The charging policy defines the differentiated charging to be used by the CHF 24 for the two or more components of traffic.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-43. (canceled)

44. A method performed by a Session Management Function (SMF) of a communication network, the method comprising:
receiving a usage report from a User Plane Function (UPF) of the communication network, the usage report including a User Equipment (UE) identifier and indicating usage information for each of two or more components of traffic associated with a same application identifier and exchanged with a UE identified by the UE identifier during a communication session involving the UE;
generating a charging report based on the usage report, the charging report including the UE identifier, the application identifier, and differentiated usage reporting for the two or more components of traffic; and
sending the charging report to a Charging Function (CHF) of the communication network, to enable differentiated charging by the CHF for the two or more components of traffic.

45. The method of claim 44, wherein the two or more components of traffic are carried in a traffic flow associated with the application identifier and comprise a principal component comprising primary traffic and an adjunct component comprising supplementary traffic, and wherein the differentiated usage reporting enables differentiated charging by the CHF for the primary traffic and the supplementary traffic.

46. The method of claim 45, wherein the primary traffic comprises application traffic constituting a service provided by an application associated with the application identifier and wherein the supplementary traffic comprises application traffic constituting advertising content exchanged with the UE in conjunction with providing the service.

47. The method of claim 44, further comprising fetching a charging policy responsive to receiving a Packet Data Unit (PDU) session establishment request from the UE, the PDU session establishment request indicating the application identifier and, in response to the charging policy indicating that differentiated usage reporting and charging applies for the application identifier, selecting the UPF to support the PDU session as the communication session, based on determining that the UPF supports differentiated usage reporting.

48. The method of claim 44, further comprising fetching one or more Packet Flow Descriptions (PFDs) associated with the application identifier and providing the one or more PFDs to the UPF, to support differentiated usage reporting by the UPF.

49. The method of claim 48, wherein providing the one or more PFDs to the UPF comprises including the one or more PFDs in a Packet Flow Control Protocol (PFCP) session establishment request sent to the UPF from the SMF in conjunction with establishing, as the communication session, a Packet Data Unit (PDU) session between the UE and a Data Network (DN) associated with the application identifier.

50. The method of claim 44, wherein the usage information for each of the two or more components of the traffic associated with the same application identifier comprises service unit consumption information for each of the two or more components, the service unit consumption information indicating a time or volume measure associated with each of the two or more components.

51. A method performed by a User Plane Function (UPF) of a communication network, the method comprising:
performing differentiated usage tracking for two or more components of traffic associated with a same application identifier, the two or more components of traffic exchanged with a User Equipment (UE) identified by a UE identifier during a communication session involving the UE;
generating a usage report that includes a UE identifier of the UE and indicates component usage information for the two or more components of the traffic, based on the differentiated usage tracking performed by the UPF; and
sending the usage report to a Session Management Function (SMF), to enable differentiated usage reporting by the SMF for the two or more components of traffic.

52. The method of claim 51, wherein the usage report comprises a Packet Flow Control Protocol (PFCP) report generated and sent by the UPF to the SMF on a periodic basis, while a corresponding PFCP session is active between the UPF and the SMF.

53. The method of claim 51, wherein the two or more components of traffic belong to a same Packet Data Unit (PDU) session established between the UE and a Data Network (DN) via the communication network, as the communication session.

54. The method of claim 51, wherein performing the differentiated usage tracking comprises distinguishing between the two or more components of traffic by detecting Server Name Indications (SNIs) within traffic exchanged with the UE for the PDU session.

55. The method of claim 51, wherein performing the differentiated usage tracking comprises using traffic heuristics to distinguish between the two or more components of traffic within traffic exchanged with the UE for the PDU session.

56. The method of claim 51, wherein performing the differentiated usage tracking comprises receiving Packet Flow Descriptors (PFDs) from the SMF and using the PFDs to distinguish between the two or more components of traffic exchanged with the UE for the PDU session.

57. The method of claim 51, further comprising performing the differentiated usage tracking in response to receiving information from the SMF indicating that differentiated usage tracking applies for the communication session.

58. The method of claim 51, wherein the two or more components of traffic are carried in a traffic flow associated with the application identifier and comprise a principal component comprising primary traffic and an adjunct component comprising supplementary traffic, and wherein the differentiated usage reporting enables differentiated charging by the CHF for the primary traffic and the supplementary traffic.

59. The method of claim 51, wherein the two or more components of traffic comprise application traffic constituting a service provided by an application associated with the application identifier, and further comprise supplementary application traffic constituting advertisements delivered to the UE in conjunction with providing the service.

60. A method performed by a CHarging Function (CHF) of a communication network, the method comprising:
receiving a charging report from a Session Management Function (SMF) of the communication network, the charging report including a User Equipment (UE) identifier, an application identifier, and differentiated usage reporting for two or more components of traffic associated with a same application identifier and exchanged during a communication session with a UE corresponding to the UE identifier;
generating one or more Charging Data Records (CDRs) based on the differentiated usage reporting for the two or more components of traffic; and
sending the one or more CDRs towards a billing system of the communication network, for differentiated charging with respect to the two or more components of traffic.

61. The method of claim 60, wherein the two or more components of traffic are carried in a traffic flow associated with the application identifier and comprise a principal component comprising primary traffic and an adjunct component comprising supplementary traffic, and wherein the one or more CDRs reflect the differentiated usage reporting for the primary traffic and the supplementary traffic.

62. The method of claim 60, further comprising, in response to signaling incoming to the CHF from a Network Exposure Function (NEF) or an Operations and Maintenance (OAM) function of the communication network, activating a charging policy associated with the application identifier, the charging policy defining the differentiated charging to be used by the CHF for the two or more components of traffic.

63. A Session Management Function (SMF) for a communication network, the SMF comprising:
communication circuitry configured to communicatively couple the SMF to one or more other nodes in the communication network; and
processing circuitry operatively associated with the communication circuitry and configured to:
receive a usage report from a User Plane Function (UPF) of the communication network, the usage report including a user equipment (UE) identifier and indicating usage information for each of two or more components of traffic associated with a same application identifier and exchanged with a UE identified by the UE identifier during a communication session involving the UE;
generate a charging report based on the usage report, the charging report including the UE identifier, the application identifier, and differentiated usage reporting for the two or more components of traffic; and
send the charging report to a Charging Function (CHF) of the communication network, to enable differentiated charging by the CHF for the two or more components of traffic.
